(19) United States
(12) Patent Application Publication
(10) Pub. No.: US 2025/0155664 A1
(43) Pub. Date: May 15, 2025

(54) OPTICAL APPARATUS WITH MOVABLE LENSES

(71) Applicant: Nurettin Aydogan, Dumont, NJ (US)

(72) Inventor: Nurettin Aydogan, Dumont, NJ (US)

(21) Appl. No.: 18/389,367

(22) Filed: Nov. 14, 2023

(51) Int. Cl. G02B 7/02; G02B 27/00

(52) U.S. Cl. CPC G02B 7/023; G02B 27/0093

(57) ABSTRACT

The disclosure is generally directed to an optical device and method of use, and in particular, an optical device with lenses moveable with a user's gaze.

### TECHNICAL FIELD

The disclosure is generally directed to an optical device and method of use, and in particular, an optical device with lenses moveable with a user's gaze.

### BACKGROUND OF THE DISCLOSURE

Current optical correction used in head mounted displays (HMD) use non-moving, static lenses in front of display screens. This setup limits the viewing angle for the user.

There is a need in the art for an optical apparatus that provides movement to the lenses by tracking eye movement using various sensors including but not limited to infrared (IR) and camera sensors. Translation of the lens along the X, Y, and Z planes as well as rotational movement is provided by mechanical and/or electromechanical means.

### SUMMARY

According to certain aspects of the present disclosure, optical apparatuses with moveable lenses are disclosed.

In one aspect, the disclosure provides an optical device, comprising a first actuator assembly and a second actuator assembly, each attached to a support member, a first optical element operably coupled to the first actuator assembly, a second optical element operably coupled to the second actuator assembly and a pupil-tracking module adapted to track a subject's pupil, the subject's pupil having an optical axis, the pupil-tracking module comprising a processor, the processor being operably linked to the first and second actuator assemblies, the first and second actuator assemblies being adapted to move the first and second optical elements, respectively, under the control of the processor.

In some embodiments, the first actuator assembly is adapted to move the first optical element along an axis that is perpendicular to the optical axis; and the second actuator assembly is adapted to move the second optical element along the axis that is perpendicular to the optical axis.

In some embodiments, the first actuator assembly is adapted to rotate the first optical element around an axis that is perpendicular to the optical axis; and the second actuator assembly is adapted to rotate the second optical element around the axis that is perpendicular to the optical axis.

In some embodiments, the first actuator assembly is adapted to move the first optical element along an axis parallel to the optical axis and the second actuator assembly is adapted to move the second optical element along the axis parallel to the optical axis.

In some embodiments, the first actuator assembly comprises a first actuator, a second actuator, a third actuator, a fourth actuator, and a fifth actuator, each operably coupled to the first optical element.

In some embodiments, the second actuator assembly comprises a sixth actuator, a seventh actuator, an eighth actuator, a ninth actuator, and a tenth actuator, each operably coupled to the second optical element.

In some embodiments, the first optical element comprises a lens, an optical filter, or a polarizer.

In some embodiments, the pupil-tracking module further comprises an illumination source and a sensor, the illumination source and sensor being electrically connected to the processor.

In some embodiments, the illumination source is adapted to illuminate the subject's pupil, thereby generating a reflected beam and the sensor is adapted to detect the reflected beam and convert the reflected beam to an electrical signal.

In some embodiments, the processor is adapted to receive the electrical signal from the sensor, transform the electrical signal into a pupil position signal, and transmit the pupil position signal to the first and second actuator assemblies.

In another aspect the disclosure provides a method of using an optical device, the device having a movable optical element, the method comprising: determining a subject's pupil position, the subject's pupil having an optical axis, and based on the pupil position, moving an optical element in relation to the optical axis.

In some embodiments, moving the optical element comprises moving the optical element along an axis perpendicular to the optical axis.

In some embodiments, moving the optical element comprises rotating the optical element around an axis perpendicular to the optical axis.

In some embodiments, moving the optical element further comprises moving the optical element along an axis parallel to the optical axis.

In some embodiments, the device comprises an illumination source adapted to illuminate the subject's pupil thereby generating a reflected beam, the method comprises illuminating the subject's pupil detecting the reflected beam with a sensor, and converting the reflected beam to an electrical signal.

In some embodiments, the device further comprises an actuator assembly, the method comprising transforming the electrical signal into a pupil position signal transmitting the pupil position signal to the actuator assembly and causing the actuator assembly to move the optical element.

### BRIEF DESCRIPTION OF THE DRAWINGS

The accompanying drawings, which are incorporated into and constitute a part of this specification, illustrate various exemplary embodiments and together with the description, serve to explain the principles of the disclosed embodiments.

FIG. 1 is a front view of an optical element and actuator assembly, in accordance with one or more embodiments of this disclosure.

FIG. 2A is a side view of an optical element and actuator assembly, in accordance with one or more embodiments of this disclosure.

FIG. 2B is a side view of an optical element and actuator assembly, in accordance with one or more embodiments of this disclosure.

FIG. 2C is a side view of an optical element and actuator assembly, in accordance with one or more embodiments of this disclosure.

FIG. 3A is a bottom view of an optical element and actuator assembly, in accordance with one or more embodiments of this disclosure.

FIG. 3B is a bottom view of an optical element and actuator assembly, in accordance with one or more embodiments of this disclosure.

FIG. 4A is an illustration of a pupil-tracking module, in accordance with one or more embodiments of this disclosure.

FIG. 4B is an illustration of a pupil-tracking module, in accordance with one or more embodiments of this disclosure.

FIG. 4C is an illustration of a pupil-tracking module, in accordance with one or more embodiments of this disclosure.

FIG. 5 is an exemplary configuration of the pupil tracking module and the first and second actuator assemblies.

FIG. 6 is an exemplary method of using the device herein provided.

FIG. 7 is an exemplary computing node.

### DETAILED DESCRIPTION

Reference will now be made in detail to the exemplary embodiments of the present disclosure, examples of which are illustrated in the accompanying drawings. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

The term “coupled,” as used herein, shall mean the joining of two or more members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

The term “operably coupled,” as used herein, refers to two members directly or indirectly joined such that motion may be transmitted from one member to the other member directly or via intermediate members.

Embodiments of the present disclosure provide a moveable lens apparatus that tracks the movement of the eye. The moveable lens apparatus can be translated along an x, y, or z axis or rotated around a central axis of the lens. The movement of the apparatus can be accomplished by a number of actuators surrounding the optical element (lens) such that the element is able to move in a controlled manner. Actuators for moving the optical element can be any suitable mechanical or electromechanical means, such as threaded mounts with locking screws for stability.

Embodiments of the present disclosure use an infrared (IR) sensor (or any other suitable type of sensor) to track the movement of the pupil of the eye of the user of a head mounted device. The tracked movement allows for the lens to focus with the user's eye movement, improving the user's focus on a display. The central axis of the user's view is tracked, wherein the user's gaze is determined by reflecting light from the pupil of the user's eye. A sensor and an illumination source are placed adjacent to the optical assembly such that the sensor reads the light from the illumination source reflected from the user's eye.

The tracked movement of the gaze is used to move the optical assembly in kind, where the motion of the optical assembly is in some proportion to the movement of the eye. For example, the motion of the optical assembly may be in direct proportion to the movement of a central optical axis of the user's gaze. A processor 230, operably connected to the optical assembly, is used to interpret the signal from the sensor to move the optical assembly as instructed.

In some aspects, the disclosure provides an optical device that comprises a first actuator assembly, a second actuator assembly, a first optical element operably coupled to the first actuator assembly, a second optical element operably coupled to the second actuator assembly, and a pupil tracking module adapted to track a subject's pupil. In some embodiments, the pupil-tracking module is adapted to track a subject's pupil where the subject's pupil has an optical axis. In some embodiments, the pupil-tracking module comprises a processor 230, the processor 230 being operably linked to the first and second actuator assemblies, the first and second actuator assemblies being adapted to move the first and second optical elements, respectively, under the control of the processor 230. In some embodiments, each actuator assembly is attached to a support member.

In some embodiments, the first actuator assembly comprises a first actuator, a second actuator, a third actuator, a fourth actuator, and a fifth actuator, each operably coupled to the first optical element. In some embodiments, the second actuator assembly comprises a sixth actuator, a seventh actuator, an eighth actuator, a ninth actuator, and a tenth actuator, each operably coupled to the second optical element.

In some embodiments, the first actuator assembly is adapted to move the first optical element along an axis that is perpendicular to the optical axis and the second actuator assembly is adapted to move the second optical element along the axis that is perpendicular to the optical axis. In some embodiments, the first actuator assembly is adapted to rotate the first optical element around an axis that is perpendicular to the optical axis and the second actuator assembly is adapted to rotate the second optical element around the axis that is perpendicular to the optical axis. In some embodiments, the first actuator assembly is adapted to move the first optical element along an axis parallel to the optical axis and the second actuator assembly is adapted to move the second optical element along the axis parallel to the optical axis.

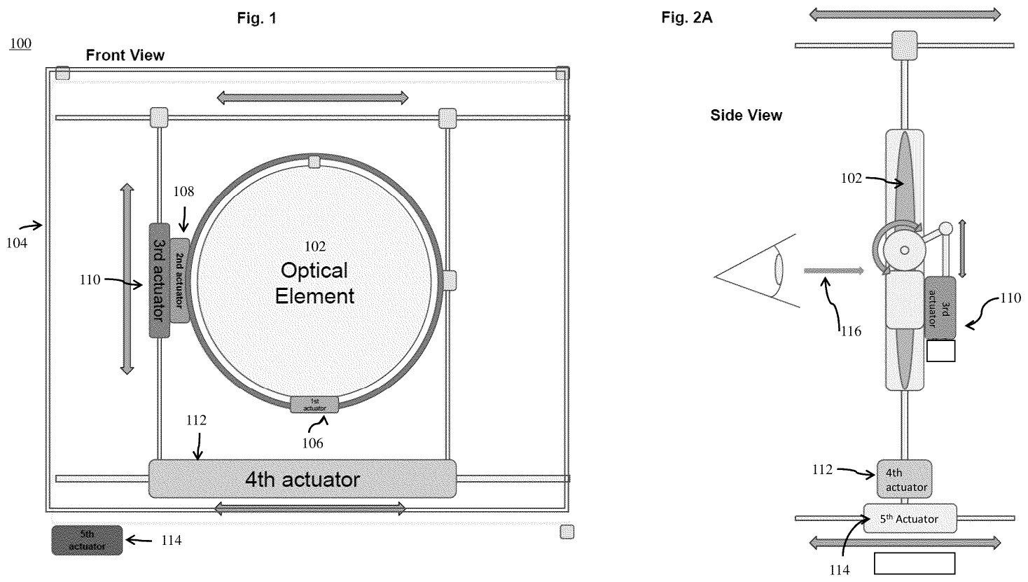

FIG. 1 is an exemplary front view of the first optical element 102 and the first actuator assembly 100. In some embodiments, the second optical element 152 and the second actuator assembly 150 as configured substantially similar to the first optical element and the first actuator assembly 100 as shown in FIG. 1. In some embodiments, the first 100 and second 150 actuator assemblies are connected. The assembly 100 may be placed between a user's eye and a display, for example in a head mounted display for virtual reality. The assembly 100 comprises a moveable optical element 102, wherein the lens is moveable by a series of actuators (such as actuators 106-114) surrounding the optical element 102. Similar to a gimbal device, the lens is moveable within the frame 104. Each actuator allows for movement along an axis, as illustrated by the arrows adjacent to each actuator. For example, first actuator 106 contacts the optical element 102 at a location on the circumference such that the optical element 102 can freely rotate around an axis running through the optical element 102 and the first actuator 106. In some embodiments, such as the embodiment illustrated by FIG. 1, the axis of rotation is vertical. This allows the optical element 102 to rotate as the user's gaze is directed towards a peripheral direction.

The second actuator 108, like the first actuator 106 is in contact with the optical element 102 at a location on the circumference such that the optical element 102 can freely rotate around an axis running through the optical element 102 and the second actuator 108. In the illustrated embodiment of FIG. 1, the axis of movement through the second actuator is horizontal, allowing for the optical element 102 to move in response to a user's gaze directed downwards or upwards.

The third actuator 110 translates the optical element 102 along an axis. The movement of the optical element 102 along the axis as controlled by the third actuator 110 may be in response to a user's gaze directed upwards, for example. When the gaze direction is upwards, the optical element may be moved upwards as well by the third actuator 110 and then rotated as appropriate to ensure that the gaze is focused through the optical element.

The fourth actuator 112 translates the optical element 102 along an axis. In some embodiments, the fourth actuator 112 is adapted to move the optical element 102 along an axis perpendicular to the optical axis 116. In some embodiments, the fourth actuator 112 is adapted to move the optical element 102 along a first axis perpendicular to the optical axis 116. In some embodiments, the third actuator 112 is coupled to an intermediate member that is adapted to move the optical element along the first axis that is orthogonal to the optical axis 116. In some embodiments the first axis is perpendicular to the optical axis and is perpendicular to a second axis. In some embodiments, the first and second axes are both orthogonal to each other and to the optical axis 116. In some embodiments, the fourth actuator 112 is a linear actuator. In some embodiments, the fourth actuator 112 is adapted to move the optical element 102 such that an angle is achieved between the optical element, the pupil, and the optical axis. In some embodiments, the fourth actuator 112 incurs a motion on the optical element 102 such that the angle achieved from the optical element 102, the pupil, and the optical axis 116 is from −90° to 90° (e.g., −89°, −88°, −87°, −86°, −85°, −84°, −83°, −82°, −81°, −80°, −79°, −78°, −77°, −76°, −75°, −74°, −73°, −72°, −71°, −70°, −69°, −68°, −67°, −66°, −65°, −64°, −63°, −62°, −61°, −60°, −59°, −58°, −57°, −56°, −55°, −54°, −53°, −52°, −51°, −50°, −49°, −48°, −47°, −46°, −45°, −44°, −43°, −42°, −41°, −40°, −39°, −38°, −37°, −36°, −35°, −34°, −33°, −32°, −31°, −30°, −29°, −28°, −27°, −26°, −25°, −24°, −23°, −22°, −21°, −20°, −19°, −18°, −17°, −16°, −15°, −14°, −13°, −12°, −11°, 10°, −9°, −8°, −7°, −6°, −5°, −4°, −3°, −2°, −1°, 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 77°, 78°, 79°, 80°, 81°, 82°, 83°, 84°, 85°, 86°, 87°, 88°, 89°, or 90°). In some embodiments, the fourth actuator 112 is operably coupled to the optical element 102.

The fifth actuator 114 translates the optical element 102 along an axis. In some embodiments, the fifth actuator 114 is adapted to move the optical element 102 along an axis perpendicular to the optical axis 116. In some embodiments, the fifth actuator 114 is adapted to move the optical element 102 along a second axis perpendicular to the optical axis 116. In some embodiments, the fifth actuator 112 is coupled to an intermediate member that is adapted to move the optical element along the second axis that is orthogonal to the optical axis 116. In some embodiments the second axis is perpendicular to the optical axis and is perpendicular to a first axis. In some embodiments, the first and second axes are both orthogonal to each other and to the optical axis 116. In some embodiments, the fifth actuator 114 is a linear actuator. In some embodiments, the fifth actuator 114 comprises a range of motion adapted to move the optical element 102 along the second axis. In some embodiments, the fifth actuator 114 is operably coupled to the optical element 102.

In some embodiments, any one or more actuators of the actuators herein provided is an electromechanical actuator (EMA). In some embodiments, the one or more actuators are the same type of EMA. In some embodiments, the one or more EMAs are of different types. In some embodiments, the EMA is a gear drive, a belt drive with a stepper or servo motor, or a screw comprising a ball screw, a lead screw, or a planetary roller screw.

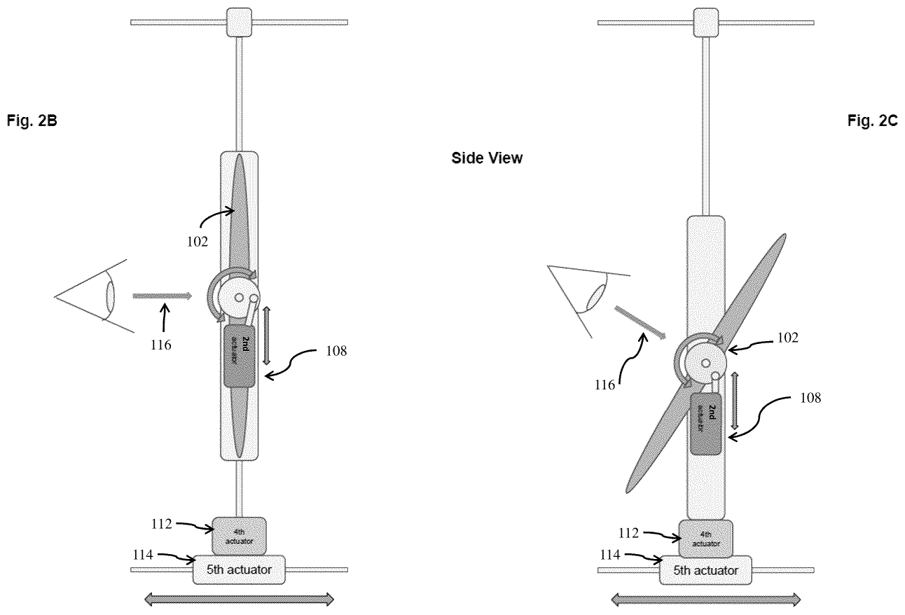

FIG. 2A is a side view of the optical element 102 and actuator assembly. As shown, an optical axis 116 illustrates the gaze of the user towards the optical element 102. In some embodiments, the optical element 102 is operably coupled to the third actuator 110. In some embodiments, the third actuator 112 is coupled to an intermediate member that is adapted to move the optical element along the first axis orthogonal to the optical axis 116. In some embodiments, the third actuator is coupled to the optical element 102 and is adapted to move the optical element 102 in a linear direction along the first axis by converting rotary motion to linear motion.

FIG. 2B is a side view of an optical element and actuator assembly, in accordance with one or more embodiments of this disclosure. As shown, an optical axis 116 illustrates a gaze of the user towards the optical element 102. In some embodiments, the optical element 102 is operably coupled to the second actuator 108. In some embodiments, the second actuator 108 is coupled to an intermediate member that is adapted to rotate the optical element around an axis running through the optical element 102 and the second actuator 108. In the illustrated embodiment of FIG. 2B, the axis of movement through the second actuator is into the page, allowing for the optical element 102 to move in response to a user's gaze directed downwards or upwards. In some embodiments, the second actuator is coupled to the optical element 102 and is adapted to rotate the optical element 102 by converting linear motion to rotary motion.

FIG. 2C is a side view of an optical element and actuator assembly, in accordance with one or more embodiments of this disclosure. As shown, the optical axis 116 illustrates the gaze of the user towards the optical element 102. In some embodiments, the optical element 102 is operably coupled to the second actuator 108. In some embodiments, the second actuator 108 is coupled to an intermediate member that is adapted to rotate the optical element around an axis running through the optical element 102. In some embodiments, the second actuator 108 is coupled to an intermediate member that is adapted to rotate the optical element around an axis running through the optical element 102 and the second actuator 108. In the illustrated embodiment of FIG. 2B, the axis of movement through the optical element 102 is into the plane of the page, allowing for the optical element 102 to move in response to a user's gaze directed downwards or upwards. In the illustrated embodiment of FIG. 2B, the user's gaze is directed downwards and the optical element 102 is rotated by the second actuator 108 by converting linear motion of the second actuator 108 to rotary motion of the optical element 102.

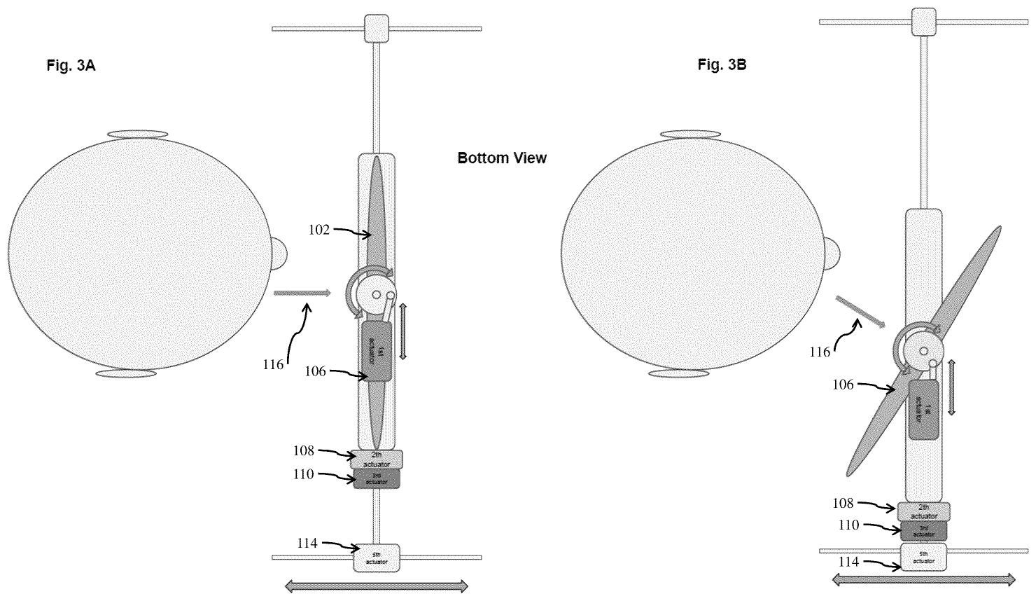

FIG. 3A is a bottom view of an optical element and actuator assembly, in accordance with one or more embodiments of this disclosure. As shown, the optical axis 116 illustrates the gaze of the user towards the optical element 102. In some embodiments, the optical element 102 is operably coupled to the first actuator 106. In some embodiments, the first actuator 106 is coupled to an intermediate member that is adapted to rotate the optical element around an axis running through the optical element 102. In some embodiments, the first actuator 106 is coupled to an intermediate member that is adapted to rotate the optical element around an axis running through the optical element 102 and the first actuator 106. In the illustrated embodiment of FIG. 3A, the axis of movement through the optical element 102 is into the plane of the page, allowing for the optical element 102 to move in response to a user's gaze directed towards a peripheral direction (e.g., leftward or rightward in relation to the user's gaze).

FIG. 3B is a bottom view of an optical element and actuator assembly, in accordance with one or more embodiments of this disclosure. As shown, the optical axis 116 illustrates the gaze of the user towards the optical element 102. In some embodiments, the optical element 102 is operably coupled to the first actuator 106. In some embodiments, the first actuator 106 is coupled to an intermediate member that is adapted to rotate the optical element around an axis running through the optical element 102. In some embodiments, the first actuator 106 is coupled to an intermediate member that is adapted to rotate the optical element around an axis running through the optical element 102 and the first actuator 106. In the illustrated embodiment of FIG. 3A, the axis of movement through the optical element 102 is into the page, allowing for the optical element 102 to move in response to a user's gaze directed towards a peripheral direction (e.g., leftward or rightward in relation to the user's gaze). In the illustrated embodiment of FIG. 3A, the user's gaze is directed leftward (i.e., since the illustration is a bottom view) and the optical element 102 is rotated by the first actuator 106 by converting linear motion of the first actuator 106 to rotary motion of the optical element 102.

In some embodiments, the optical element is a lens, an optical filter, or a polarizer. In some embodiments, the optical element is an assembly of optical elements comprising up to four (e.g., up to 2, up to 3, or up to 4) optical elements coupled to each other (e.g., a compound lens).

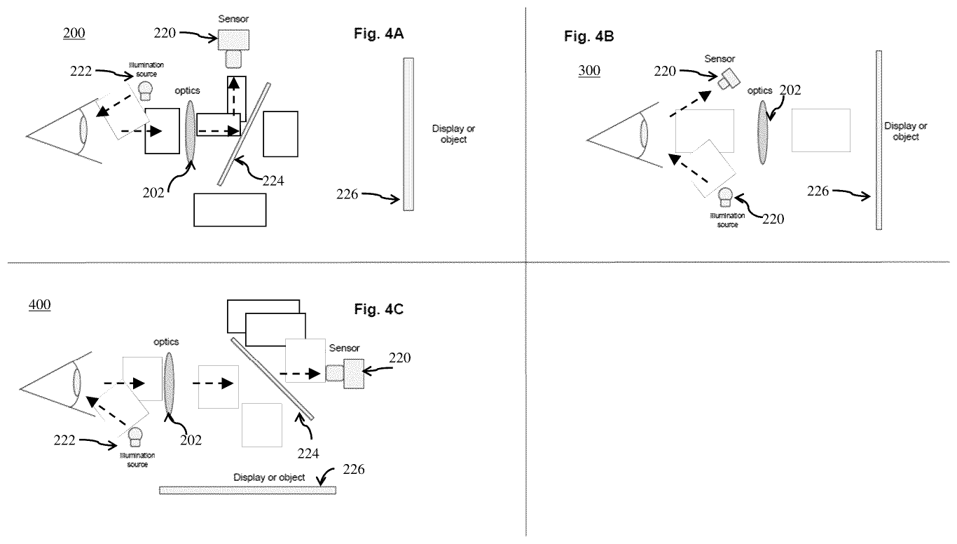

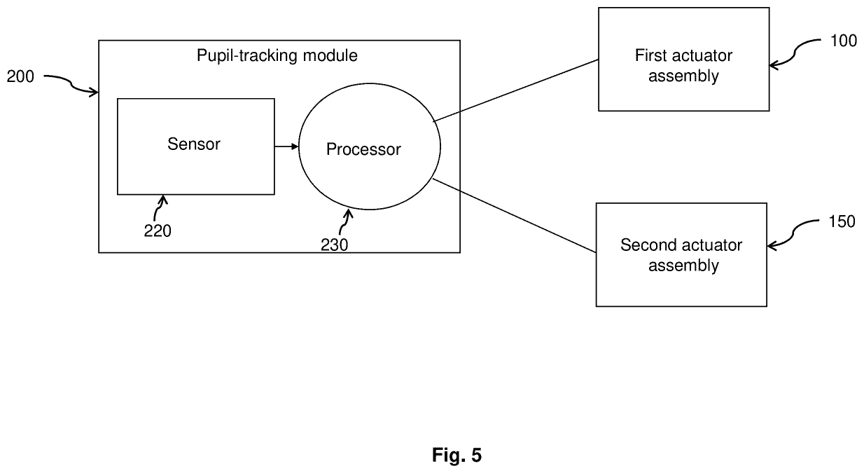

FIG. 4A is an illustration of an pupil-tracking module 200, in accordance with one or more embodiments of this disclosure. In some embodiments, the pupil-tracking module 200 comprises an illumination source 222 and a sensor 220. In some embodiments, the pupil-tracking module 200 further comprises a dichroic reflector 224. In some embodiments, illumination source 222 is an visible light source, an infrared illumination source, or a near infrared illumination source. In some embodiments, the illumination source 222 emits light of a wavelength from 750 nm to 1000 nm (e.g., 750 nm, 775 nm, 800 nm, 825 nm, 850 nm, 875 nm, 900 nm, 925 nm, 950 nm, 975 nm, or 1000 nm). In some embodiments, the illumination source 222 can emit light continuously or in pulses. In some embodiments, the illumination source 222 is adapted to illuminate at least a portion of a user's eye. In some embodiments, the illumination source 222 is positioned outside of the optical axis 116. FIG. 4B is an illustration of an pupil-tracking module 300, in accordance with one or more embodiments of this disclosure. FIG. 4C is an illustration of an pupil-tracking module 400, in accordance with one or more embodiments of this disclosure.

In some embodiments, the sensor 220 is adapted to detect light emitted by the illumination source 222 and reflected from the user's eye (as shown in FIG. 4A-4C). In some embodiments, the sensor 220 is an infrared sensor, a near infrared sensor, or a visible light sensor. In some embodiments, the sensor 220 detects light of a wavelength from 750 nm to 1000 nm (e.g., 750 nm, 775 nm, 800 nm, 825 nm, 850 nm, 875 nm, 900 nm, 925 nm, 950 nm, 975 nm, or 1000 nm). In some embodiments, the sensor is a charge-coupled device (CCD) sensor. In some embodiments, the sensor is a complementary metal oxide semiconductor (CMOS) sensor. The sensor 220 herein provided may be any infrared sensor known in the art.

In some embodiments, the pupil-tracking module 200 comprises a dichroic reflector 224. In some embodiments, the dichroic reflector 224 reflects light emitted by the illumination source 222, reflected from a user's eye, and into the sensor 220 (as shown in FIG. 4A). In some embodiments, the dichroic reflector 224 transmits light emitted by the illumination source 222, reflected from a user's eye, and into the sensor 220 (as shown in FIG. 4C). In some embodiments, the pupil-tracking module 200 does not comprise a dichroic reflector 224 and the light emitted by the illumination source 222 reflects from a user's eye and is detected by the sensor 220 without reflecting from or transmitting across a dichroic reflector (as shown in FIG. 4B). In some embodiments, the dichroic reflector 224 is adapted to transmit from 0.1% to 100% (e.g., 0.1%, 0.5%, 1%, 2%, 3%, 4%, 5%, 6%, 7%, 8%, 9%, 10%, 20%, 30%, 40%, 50%, 60%, 70%, 80%, 90%, or 100%) of light from the illumination source 222. In some embodiments, the dichroic reflector 224 is adapted to reflect from 0.1% to 100% (e.g., 0.1%, 0.5%, 1%, 2%, 3%, 4%, 5%, 6%, 7%, 8%, 9%, 10%, 20%, 30%, 40%, 50%, 60%, 70%, 80%, 90%, or 100%) of light from the illumination source 222.

To move the optical elements, the optical assembly may be in electric communication with a processor 230 (not shown). The processor 230 may receive a signal from the sensor corresponding to the position of the pupil, where the signal is indicative of the light reflected from the pupil. The signal is then ingested by the processor 230 and a command is sent to the first and/or second actuator assemblies to move the optical elements (e.g., optical lenses) accordingly. This movement may be in direct proportion to the movement of the pupil. Calibration may be required prior to use of the processor 230—linked headset, where pupil measurement is specific to a user or a headset in a head mounted device. With this electrical signal, the processor 230 then transforms the electrical signal into a pupil position, and transmits the pupil position signal to the first and second actuators.

In some embodiments, the pupil-tracking module 200 uses a video-based eye tracking system. In some embodiments, a camera (or sensor) focuses on one or both pupils and records pupil movement as the user looks at some kind of stimulus. In some embodiments, the pupil-tracking module uses the center of the pupil and infrared and/or near-infrared non-collimated light to create corneal reflections (CR). The vector between the pupil center and the corneal reflections can be used to compute the point of regard on a surface or the gaze direction emanating from the user. There may be a simple calibration procedure of the individual before using the eye tracker.

Two infrared and/or near-infrared (also known as active light) pupil-tracking techniques may be used: bright-pupil and dark-pupil. The difference in pupil-tracking techniques is based on the location of the illumination source with respect to the optics. In some embodiments, the illumination is coaxial with the optical path and the eye acts as a retroreflector as the light reflects off the retina, creating a bright pupil effect similar to red eye. If the illumination source is offset from the optical path, the pupil appears dark because the retroreflection from the retina is directed away from the camera.

In some embodiments, the pupil-tracking module 200 uses bright-pupil tracking to create greater iris/pupil contrast that allows for more robust pupil-tracking with all iris pigmentation and greatly reduces interference caused by eyelashes and other obscuring features. In some embodiments, bright-pupil tracking used by the pupil-tracking module 200 allows for pupil-tracking to occur in a variety of lighting conditions ranging from total darkness to very bright.

In some embodiments, the pupil-tracking module 200 uses an eye and/or gaze tracking software known in the art (e.g., open-source software). In some embodiments, pupil-tracking module 200 uses a software as described in https://www.pygaze.org/about/; https://link.springer.com/article/10.3758/si3428-013-0422-2; OpenCV https://opencv.org; U.S. Pat. No. 5,231,674; U.S. Publication No. 20030098954 A1; U.S. Pat. Nos. 5,416,317; 5,678,066; 5,471,542; PCT/DE2000/003843; U.S. Pat. No. 6,152,563; U.S. Publication No. 20040252277; U.S. Pat. Nos. 5,966,197; 6,433,760; 6,120,461; or U.S. Pat. No. 5,583,795; each is herein incorporated by reference in their entireties.

In certain aspects, herein provided is a method of using an optical device as herein disclosed. In some embodiments, the method comprises determining a subject's pupil position, the subject's position comprises an optical axis, and based on the pupil position, moving an optical element in relation to the optical axis.

In some embodiments, moving the optical element comprises moving the first and/or second optical elements as herein described along an axis perpendicular to the optical axis. In some embodiments, moving the optical element comprises moving the first and/or second optical elements around an axis perpendicular to the optical axis. In some embodiments, moving the optical element comprises moving the first and/or second optical elements along an axis parallel to the optical axis. In some embodiments, moving the optical element comprises moving the first and/or second optical elements along one or more axes substantially simultaneously. In some embodiments, moving the optical element comprises moving the first and/or second optical elements along and/or around one or more axes sequentially.

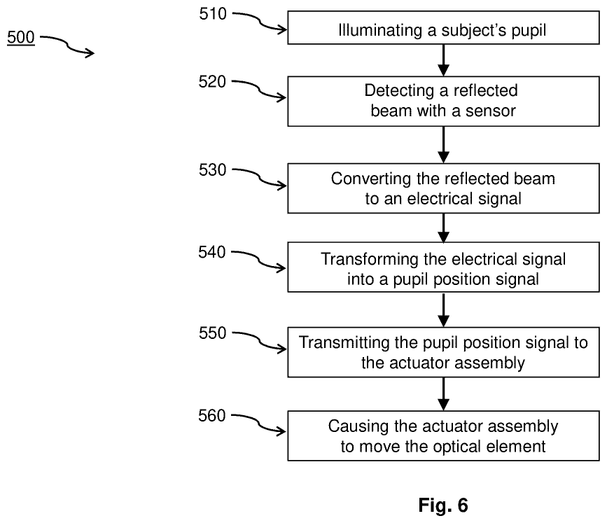

In some embodiments, the method of using the device 500 further comprises the steps as shown in in FIG. 6. In some embodiments, the method of using the device comprises illuminating a subject's pupil 510, detecting a reflected beam (e.g., a beam of light reflected from the subject's pupil) with a sensor 520, converting the reflected beam to an electrical signal 530, transforming the electrical signal into a pupil position signal 540, transmitting the pupil position signal to the actuator assembly 550, and causing the actuator assembly to move the optical element 560. In some embodiments, the any one of the steps in the method of using the device (e.g., 510-560), are repeatable, and/or once step 560 is performed the method is resumed from step 510.

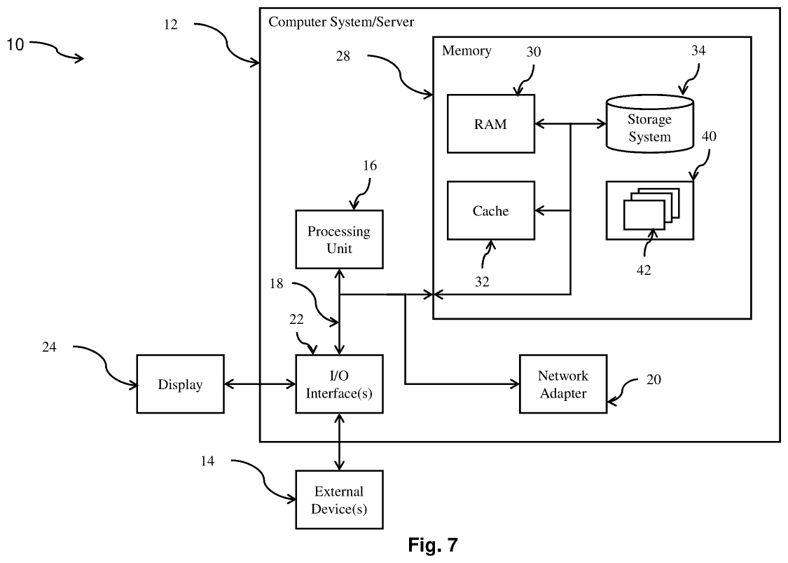

Referring now to FIG. 7, a schematic of an example of the pupil-tracking module 200 operably linked to the first actuator assembly 100 and the second actuator assembly 150. In some embodiments, the pupil-tracking module comprises a processor 230. In some embodiments, the processor comprises a computing node 10 as shown in FIG. 6. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor 230 systems, microprocessor 230—based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 12 in computing node 10 is shown in the form of a general-purpose computing device. The components of computer system/server 12 may include, but are not limited to, one or more processor 230s or processing units 16, a system memory 28, and a bus 18 that couples various system components including system memory 28 to processor 230 16.

Bus 18 represents one or more of any of several types of bus structures, including a memory bus or memory controller, a peripheral bus, an accelerated graphics port, and a processor 230 or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor 230 to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

These computer readable program instructions may be provided to a processor 230 of a general purpose computer, special purpose computer, or other programmable data processing apparatus to produce a machine, such that the instructions, which execute via the processor 230 of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. An optical device, comprising:
a first actuator assembly; and
a second actuator assembly,
each attached to a support member,
a first optical element operably coupled to the first actuator assembly;
a second optical element operably coupled to the second actuator assembly; and
a pupil-tracking module adapted to track a subject's pupil, the subject's pupil having an optical axis,
the pupil-tracking module comprising a processor, the processor being operably linked to the first and second actuator assemblies, the first and second actuator assemblies being adapted to move the first and second optical elements, respectively, under the control of the processor.

2. The device of claim 1, wherein:
the first actuator assembly is adapted to move the first optical element along an axis that is perpendicular to the optical axis; and
the second actuator assembly is adapted to move the second optical element along the axis that is perpendicular to the optical axis.

3. The device of claim 1, wherein:
the first actuator assembly is adapted to rotate the first optical element around an axis that is perpendicular to the optical axis; and
the second actuator assembly is adapted to rotate the second optical element around the axis that is perpendicular to the optical axis.

4. The device of claim 2, wherein:
the first actuator assembly is adapted to move the first optical element along an axis parallel to the optical axis; and
the second actuator assembly is adapted to move the second optical element along the axis parallel to the optical axis.

5. The device of claim 1, wherein the first actuator assembly comprises a first actuator, a second actuator, a third actuator, a fourth actuator, and a fifth actuator, each operably coupled to the first optical element.

6. The device of claim 1, wherein the second actuator assembly comprises a sixth actuator, a seventh actuator, an eighth actuator, a ninth actuator, and a tenth actuator, each operably coupled to the second optical element.

7. The device of claim 1, wherein the first optical element comprises a lens, an optical filter, or a polarizer.

8. The device of claim 1, wherein the pupil-tracking module further comprises an illumination source; and
a sensor,
the illumination source and sensor being electrically connected to the processor.

9. The device of claim 8, wherein:
the illumination source is adapted to illuminate the subject's pupil, thereby generating a reflected beam; and
the sensor is adapted to detect the reflected beam and convert the reflected beam to an electrical signal.

10. The device of claim 9, wherein the processor is adapted to:
receive the electrical signal from the sensor;
transform the electrical signal into a pupil position signal; and
transmit the pupil position signal to the first and second actuator assemblies.

11. A method of using an optical device,
the device having a movable optical element;
the method comprising:
determining a subject's pupil position, the subject's pupil having an optical axis; and
based on the pupil position, moving an optical element in relation to the optical axis.

12. The method of claim 11, wherein moving the optical element comprises:
moving the optical element along an axis perpendicular to the optical axis.

13. The method of claim 11, wherein moving the optical element comprises:
rotating the optical element around an axis perpendicular to the optical axis.

14. The method of claim 11, wherein moving the optical element comprises:
moving the optical element along an axis parallel to the optical axis.

15. The method of claim 11, wherein the device comprises an illumination source adapted to illuminate the subject's pupil thereby generating a reflected beam,
the method comprising:
illuminating the subject's pupil;
detecting the reflected beam with a sensor; and
converting the reflected beam to an electrical signal.

16. The method of claim 15, wherein the device further comprises an actuator assembly,
the method comprising:
transforming the electrical signal into a pupil position signal;
transmitting the pupil position signal to the actuator assembly; and
causing the actuator assembly to move the optical element.
